(19) United States
(12) Patent Application Publication
(10) Pub. No.: US 2026/0031263 A1
(43) Pub. Date: Jan. 29, 2026

(54) COIL DEVICE

(71) Applicant: TDK CORPORATION, Tokyo (JP)

(72) Inventors: Toshiyuki Horikawa, Tokyo (JP); Myungsung Kim, Tokyo (JP); Kiho Hwang, Tokyo (JP)

(73) Assignee: TDK CORPORATION, Tokyo (JP)

(21) Appl. No.: 19/236,551

(22) Filed: Jun. 12, 2025

(30) Foreign Application Priority Data
Jul. 29, 2024 (JP) 2024-122435

(51) Int. Cl. H01F 27/02; H01F 27/24; H01F 27/28; H01F 27/32

(52) U.S. Cl. CPC H01F 27/025; H01F 27/24; H01F 27/2823; H01F 27/325

(57) ABSTRACT

A coil device including a bobbin, a first wound wire part arranged around an outer circumference, a second wound wire part arranged around an outer circumference of the first, a first and second core installed to the bobbin, a case at least accommodating the bobbin, and a resin provided therein. The first core includes a first base part and a pair of first outer leg parts projecting therefrom, which are positioned opposite to each other in a first direction perpendicular to an axis direction of the bobbin. The second core includes a second base part and a pair of second outer leg parts projecting therefrom, which are positioned opposite to each other in the first direction. The pairs of outer leg parts are spaced apart so as to form a space therebetween along the second direction perpendicular to the axis direction and the first direction.

### CROSS-REFERENCE TO RELATED APPLICATIONS

This application claims priority to Japanese patent application No.2024-122435 filed on July 29, 2024 which is incorporated herein by reference in its entirety.

### TECHNICAL FIELD

The present disclosure relates to a coil device.

### BACKGROUND

Patent Document 1 discloses a technique for cooling a coil device which forms a thorough hole in a core and also introduces cooling air to the inside of the core via the through hole. By supplying the cooling air to the inside of the core via the through hole, the core and the coil can be cooled, and a heat dissipation property of the coil device can be enhanced.

### PRIOR ART DOCUMENT

### Patent Document

### Patent Document 1: JP Patent Application Laid Open No.2012-156351

### SUMMARY

A coil device according to one aspect of the present disclosure includes:
a bobbin;
a first wound wire part arranged around an outer circumference of the bobbin;
a second wound wire part arranged directly or indirectly around an outer circumference of the first wound wire part;
a first core and a second core installed to the bobbin;
a case at least accommodating the bobbin; and
a resin provided in the case;
wherein the first core includes a first base part and a pair of first outer leg parts projecting from the first base part, and one outer leg part and the other outer leg part of the pair of first outer leg parts are positioned opposite to each other in a first direction perpendicular to an axis direction of the bobbin,
the second core includes a second base part and a pair of second outer leg parts projecting from the second base part, and one outer leg part and the other leg part of the pair of second outer leg part are positioned opposite to each other in the first direction, and
the pair of first outer leg parts and the pair of second outer leg parts are spaced apart so as to form a space between the pair of first outer leg parts and the pair of second outer leg parts along the second direction perpendicular to the axis direction and the first direction.

### BRIEF DESCRIPTION OF DRAWINGS

FIG. 1 is a perspective view of a coil device according to a first embodiment.

FIG. 2 is an exploded perspective view of the coil device shown in FIG. 1.

FIG. 3 is an exploded perspective view of a bobbin shown in FIG. 2.

FIG. 4 is a perspective view of the bobbin and a wound wire part shown in FIG. 2.

FIG. 5 is a cross-section view along a V-V line shown in FIG. 1.

FIG. 6 is a cross-section view along a VI-VI line shown in FIG. 1.

FIG. 7 is a plan view of the bobbin to which a first core, a second core, and a third core are installed.

FIG. 8 is a side view showing the coil device of FIG. 1 without showing the case.

FIG. 9 is a perspective view of the coil device of FIG. 1 without showing the case.

FIG. 10 is a perspective view of the case shown in FIG. 1.

FIG. 11 is a perspective view of a coil device according to a second embodiment.

FIG. 12 is a perspective view of a bobbin of the coil device shown in FIG. 11.

FIG. 13 is a side view of the coil device of FIG. 11 without showing the case.

FIG. 14 is a cross-section view along XIV-XIV line shown in FIG. 11.

### DETAILED DESCRIPTION

In below, the embodiments of the present disclosure are described by referring to the figures. Note that, the figures are schematic and exemplary representations for better understanding of the present disclosure, and the appearance and dimensional ratio may not be the exact same as the actual coil device. Also, the present disclosure is not limited to the below described embodiments.

### First Embodiment

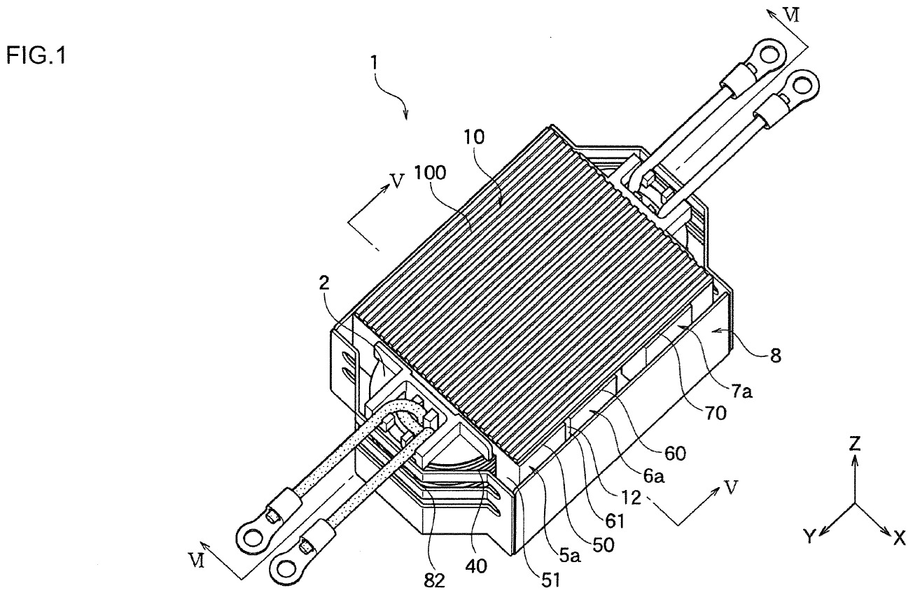

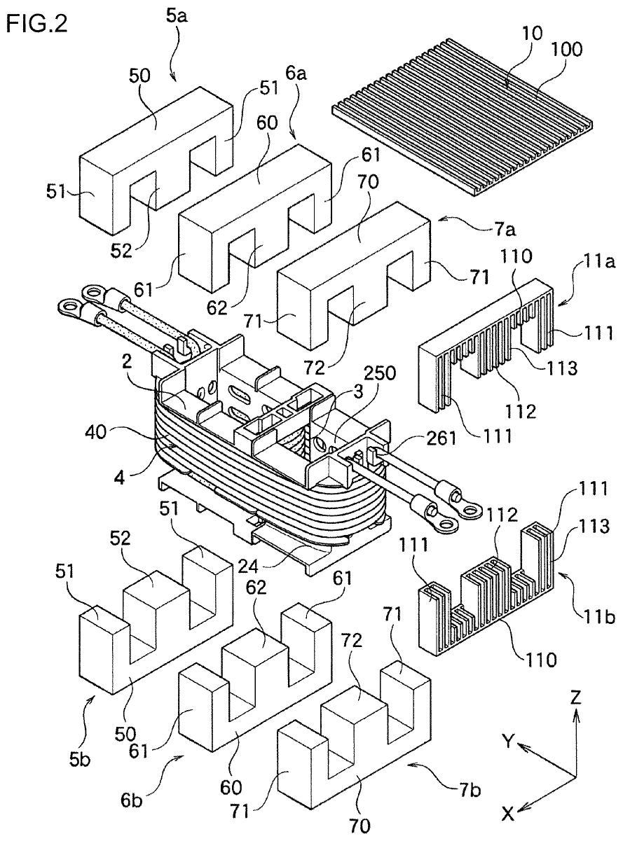

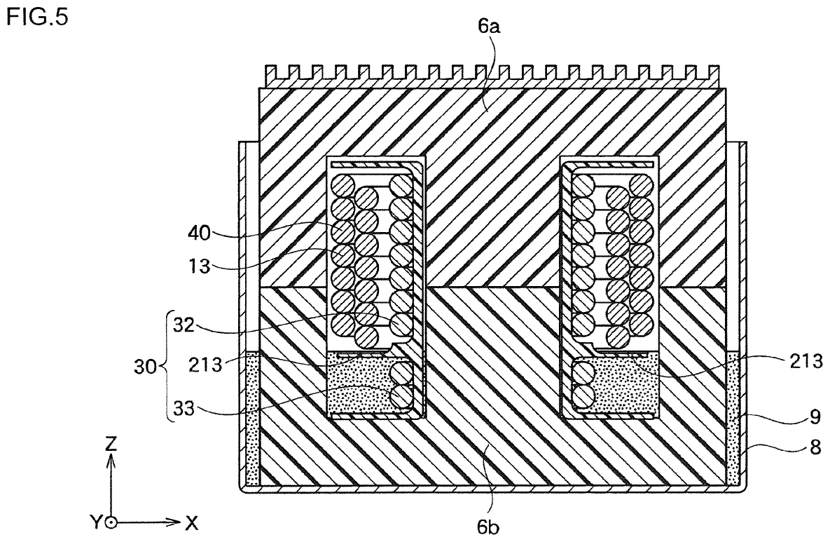

A coil device 1 of the first embodiment shown in FIG. 1 is a composite coil device which includes both functions as a transformer and an inductor, and it is mounted on power circuits or so of electronic devices. As shown in FIG. 2, the coil device 1 at least includes a bobbin 2, a first wire 3, a second wire 4, first cores 5a and 5b, second cores 6a and 6b, a case 8 (FIG. 1), and a resin 9 (FIG. 5). The coil device 1 further includes third cores 7a and 7b, a first heat dissipation member 10, and second heat dissipation members 11a and 11b; however, these are not essential configurations and may be omitted.

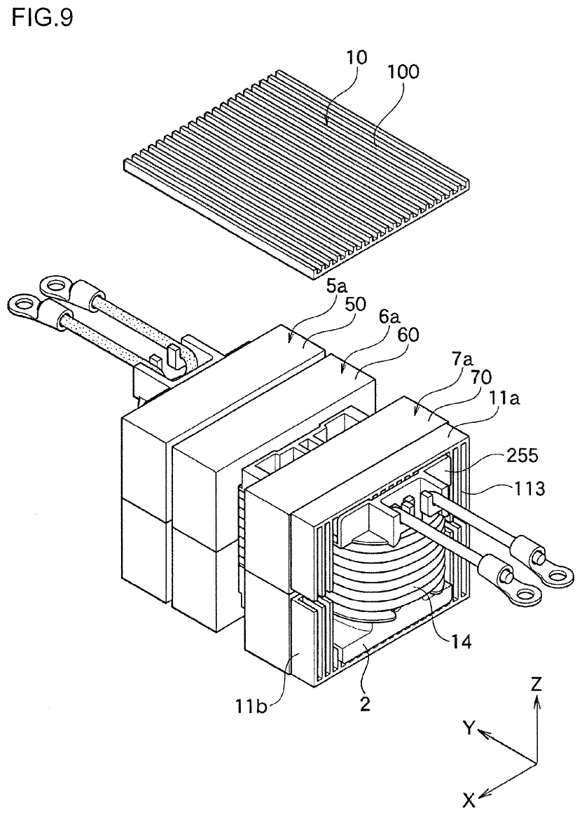

The first cores 5a and 5b, the second cores 6a and 6b, and the third cores 7a and 7b are respectively E-shaped cores, and are installed to the bobbin 2 (FIG. 9). The first cores 5a and 5b, the second cores 6a and 6b, and the third cores 7a and 7b have the same shapes; however, these may be different shapes. The first core 5a is assembled with the first core 5b, the second core 6a is assembled with the second core 6b, and the third core 7a is assembled with the third core 7b. The second core 6a is next to the first core 5a, and the third core 7a is next to the second core 6a. The second core 6b is next to the first core 5b, and the third core 7b is next to the second core 6b.

The first cores 5a and 5b each includes a base part 50, a pair of outer leg parts 51, and a middle leg part 52. The second cores 6a and 6b each includes a base part 60, a pair of outer leg parts 61, and a middle leg part 62. The third cores 7a and 7b each includes a base part 70, a pair of outer leg parts 71, and a middle leg part 72.

In below, the X-axis is an axis along the direction which the pair of outer leg parts 51 are positioned opposite to each other. Also, the Y-axis is an axis along the direction which the first core 5a and the second core 6a are facing each other. Also, the Z-axis is an axis which corresponds to an axis direction of the bobbin 2. The X-axis, the Y-axis, and the Z-axis are perpendicular to each other.

In the present disclosure, the positive direction in the Z-axis is defined as an upper side, and the negative direction in the Z-axis is considered a lower side. Note that, the upper side in the Z-axis direction does not necessarily match the upper side in the vertical direction. Also, the lower side in the Z-axis direction does not necessarily match the lower side in the vertical direction.

The pair of outer leg parts 51 projects from the base part 50, and the outer leg parts 51 are positioned opposite to each other along the direction perpendicular to the axis direction of the bobbin 2 (that is, along the X-axis direction). The outer leg parts 51 are respectively positioned at both ends of the base part 50 in the X-axis direction, and the outer leg parts 51 both extend along the direction perpendicular to the base part 50 (extends in the Z-axis direction).

Note that, in the present disclosure, “perpendicular” does not necessarily refer to strictly perpendicular, and “perpendicular” in the present disclosure includes a margin of error of ±Δθ° or less with respect to precise perpendicular angle (although it is not particularly limited, for example, it may be ±Δθ=3). Also, “parallel” in the present disclosure does not necessarily refer to strictly parallel and “parallel” in the present disclosure includes a margin of error of ±Δθ° or less with respect to precise parallel (although it is not particularly limited, for example, it may be ±Δθ=3).

The middle leg part 52 is positioned between the pair of outer leg parts 51, and projects from the base part 50. The middle leg part 52 extends in the direction perpendicular to the base part 50.

The pair of outer leg parts 61 projects from the base part 60, and the outer leg parts 61 are positioned opposite to each other in the X-axis direction perpendicular to the axis direction of the bobbin 2. The outer leg parts 61 are respectively positioned at the both end parts in the X-axis direction of the base part 60, and the outer leg parts 61 extend in the direction perpendicular to the base part 60 (that is, the outer leg parts 61 extend in the Z-axis direction). The middle leg part 62 is positioned between the pair of outer leg parts 61, and projects from the base part 60. The middle leg part 62 extends in a direction perpendicular to the base part 60.

The pair of outer leg parts 71 projects from the base part 70, and the outer leg parts 71 are positioned opposite to each other in the X-axis perpendicular to the axis direction of the bobbin 2. The outer leg parts 71 are positioned at the both end parts in the X-axis direction of the base part 70, and the outer leg parts 71 extend in the direction perpendicular to the base part 70 (that is, the outer leg parts 71 extend in the Z-axis direction). The middle leg part 72 is positioned between the pair of outer leg parts 71, and projects from the base part 70. The middle leg part 72 extends in a direction perpendicular to the base part 70.

The outer leg parts 51, 61, and 71 have cross-sections (the cross-sections perpendicular to the Z-axis) of rectangular shapes; however, the cross-section shapes may be a square shape, other polygonal shapes, a circular shape, an oval shape, and any other shapes. Also, the middle leg parts 52, 62, and 72 have cross-sections of rectangular shapes; however, the cross-section shapes may be a square shape, other polygonal shapes, a circular shape, an oval shape, and any other shapes.

Each of the first cores 5a and 5b may be configured of a plurality of cores. For example, each of the first cores 5a and 5b may be configured by assembling a plurality of I-type cores into a E-like shape. Alternatively, each of the first cores 5a and 5b may be configured by assembling a U-type core and an I-type core into an E-like shape. The same applies to the second cores 6a and 6b and the third cores 7a and 7b.

Also, either one of the first cores 5a and 5b may be an E-type core and the other one may be an I-type core. The same applies to the second cores 6a and 6b and the third cores 7a and 7b.

The first core 5a, the second core 6a, and the third core 7a are arranged while taking spaces between each other along the Y-axis direction. The first core 5b, the second core 6b, and the third core 7b are arranged while taking spaces between each other along the Y-axis direction.

When the first core 5a and the second core 5b are installed to the bobbin 2, tips of the pair of outer leg parts 51 of the first core 5a and tips of the pair of outer leg parts 51 of the first core 5b may be in contact, or may be apart so that gaps are formed between them. Also, when the second cores 6a and 6b are installed to the bobbin 2, tips of the pair of outer leg parts 61 of the second core 6a and tips of the pair of outer leg parts 61 of the second core 6b may be in contact, or may be apart so that gaps are formed between them. Also, when the third cores 7a and 7b are installed to the bobbin 2, tips of the pair of outer leg parts 71 of the third core 7a and tips of the pair of outer leg parts 71 of the third core 7b may be in contact, or may be apart so that gaps are formed between them.

When the first cores 5a and 5b are installed to the bobbin 2, a tip of the middle leg part 52 of the first core 5a may be in contact with a tip of the middle leg part 52 of the first core 5b, or may be apart so that a gap is formed between them. Also, when the second cores 6a and 6b are installed to the bobbin 2, a tip of the middle leg part 62 of the second core 6a may be in contact with a tip of the middle leg part 62 of the second core 6b, or may be apart so that a gap is formed between them. Also, when the third cores 7a and 7b are installed to the bobbin 2, a tip of the middle leg part 72 of the third core 7a may be in contact with a tip of the middle leg part 72 of the third core 7b, or may be apart so that a gap is formed between them.

The first cores 5a and 5b are made of materials including a magnetic material and a resin. The magnetic material included in the first cores 5a and 5b is not particularly limited, and examples include ferrites (Ni—Zn-based ferrite, Mn—Zn-based ferrite, etc.) and metal magnetic materials (Fe—Ni alloy, Fe—Si alloy, Fe—Si—Cr alloy, Fe—Co alloy, Fe—Si—Al alloy, amorphous iron, etc.). The resin included in the first cores 5a and 5b is not particularly limited, and examples include an epoxy resin, a phenol resin, a polyester resin, a polyurethane resin, and a polyimide resin. The first cores 5a and 5b may be a sintered body of the metal magnetic materials. The same applies to the second cores 6a and 6b and the third cores 7a and 7b.

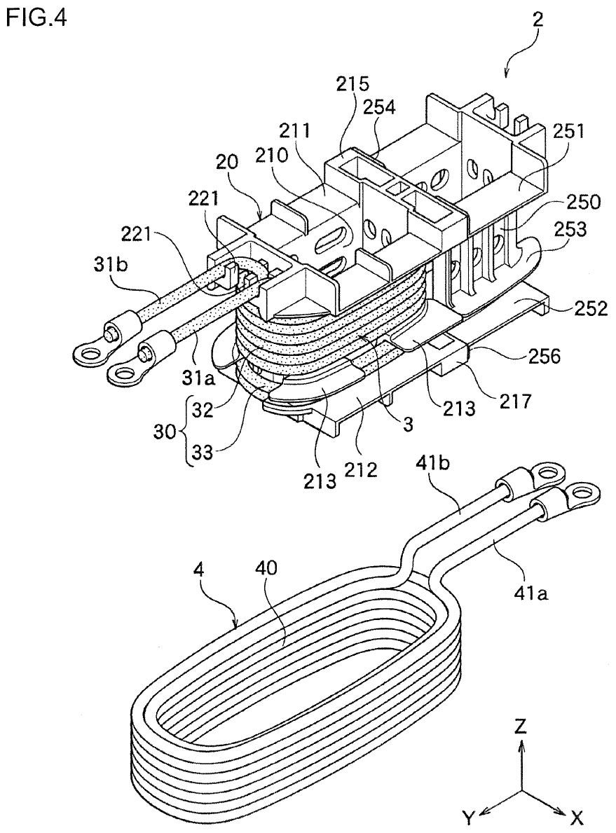

As shown in FIG. 4, the first wire 3 includes a wound wire part 30 and leadout parts 31a and 31b which are pulled out from the wound wire part 30. The wound wire part 30 is arranged directly or indirectly to the outer circumference of the first bobbin 20 which configures the bobbin 2. The wound wire part 30 is formed by winding the first wire 30 spirally around the outer circumference of the first bobbin 20. A winding axis direction of the wound wire part 30 corresponds to the Z-axis direction. The leadout part 31a is one end of the first wire 3, and the leadout part 31b is the other end of the first wire 3. Terminals are installed to both of the leadout parts 31a and 31b.

The second wire 4 includes a wound wire part 4 and lead-out parts 41a and 41b which are pulled out from the wound wire part 40. As shown in FIG. 2, at least part of the wound wire part 40 (in the present embodiment, part of the wound wire part 40) is arranged directly or indirectly on the outer circumference of the wound wire part 30. In the present embodiment, part of the wound wire part 40 is arranged directly or indirectly on the outer circumference of a main body 250 of the second bobbin 24 configuring the bobbin 2. The wound wire part 40 is formed by winding the second wire 4 spirally around the outer circumference of the wound wire part 30 and the outer circumference of the main body 250. A winding axis direction of the wound wire part 40 corresponds to the Z-axis direction. Either one of the wound wire parts 30 and 40 functions as a primary coil and the other one functions as a secondary coil.

As shown in FIG. 4, the leadout part 41a is one end of the second wire 4 and the leadout part 41b is the other end of the second wire 4. Terminals are installed to the leadout parts 41a and 41b.

The first wire 3 and the second wire 4 are, for example, insulation coated wires. The first wire 3 and the second wire 4 are made of known wires such as AIW (polyamide-imide copper wire), UEW (polyurethane enameled copper wire), and PEW (polyester enameled copper wire). The first wire 3 and the second wire 4 are round wires; however, these wires may be square wires, stranded wires, Litz wires, braided wires, etc. Materials configuring core wires of the first wire 3 and the second wire 4 are not particularly limited, and examples of the materials include copper, copper alloy, silver, and nickel. The diameters of the first wire 3 and the second wire 4 are not particularly limited, and for example, the diameters may be 10 to 100 μm. The diameter of the first wire 3 and the diameter of the second wire 4 are about the same; however, these may be different.

Note that, in the present disclosure, “the same”, “about the same”, and “similar” do not necessarily only mean that the physical amounts of the plurality of targets are exactly “the same”, “about the same”, and “similar”; and when comparing the physical amounts of the plurality of targets, a margin of ±Δ% is included in the context of “the same”, “about the same”, and “similar” (for example, Δ=7, 5, or 3, although it is not particularly limited to this).

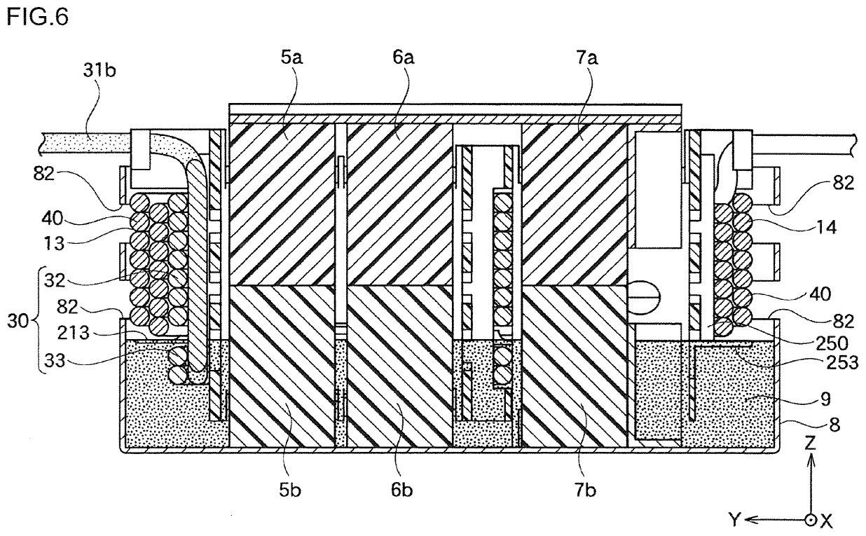

As shown in FIG. 6, at least one of the wound wire part 30 and the wound wire part 40 includes a transformer part 13 functioning as a transformer, and an inductor part 14 functioning as an inductor. The transformer part 13 at least includes the wound wire part 30, and the wound wire part 40 layered on the wound wire part 30 along the radial direction of the wound wire part 30. The first cores 5a and 5b and the second cores 6a and 6b are arranged to the transformer part 13. The inductor part 14 at least includes the wound wire part 40. The third cores 7a and 7b are arranged to the inductor part 14.

The wound wire part 30 includes an overlapping part 32 and a non-overlapping part 33. The overlapping part 32 and the wound wire part 40 overlap along the radial direction of the wound wire part 30, and the wound wire part 30 is covered by the wound wire part 40. In the non-overlapping part 33, the wound wire 40 and the wound wire 30 are not overlapping along the radial direction of the wound wire part 30, and the non-overlapping part 33 projects downward from the wound wire part 40 along the axis direction of the wound wire part 30. The number of turns of the wire in the non-overlapping part 33 along the axis direction of the wound wire part 30 is 2 turns, and it is less than the number of turns of the wire in the overlapping part 32 along the axis direction of the wound wire part 30. Note that, the number of turns of the wire in the non-overlapping part 33 along the axis direction of the wound wire part 30 may be the same as or more than the number of turns of the wire in the overlapping part 32 along the axis direction of the wound wire part 30.

A part of the bobbin 2 (that is, a middle flange 213 of the first bobbin 20) is arranged between the overlapping part 32 and the non-overlapping part 33. Therefore, the overlapping part 32 and the non-overlapping part 33 are spaced apart along the axis direction of the wound wire part 30.

The non-overlapping part 33 is arranged inside the resin 9 which fills the case 8. In the present embodiment, the entire non-overlapping part 33 is disposed inside the resin 9; however, the non-overlapping part 33 may be partially exposed from the resin 9 (for example, an upper end part of the non-overlapping part 33 may be exposed).

On the other hand, the overlapping part 32 is arranged outside of the resin 9, and it is exposed from the resin 9. In the present embodiment, the entire overlapping part 32 is exposed from the resin 9; however, the overlapping part 32 (for example, a lower end part of the overlapping part 32) may be partially arranged inside the resin 9.

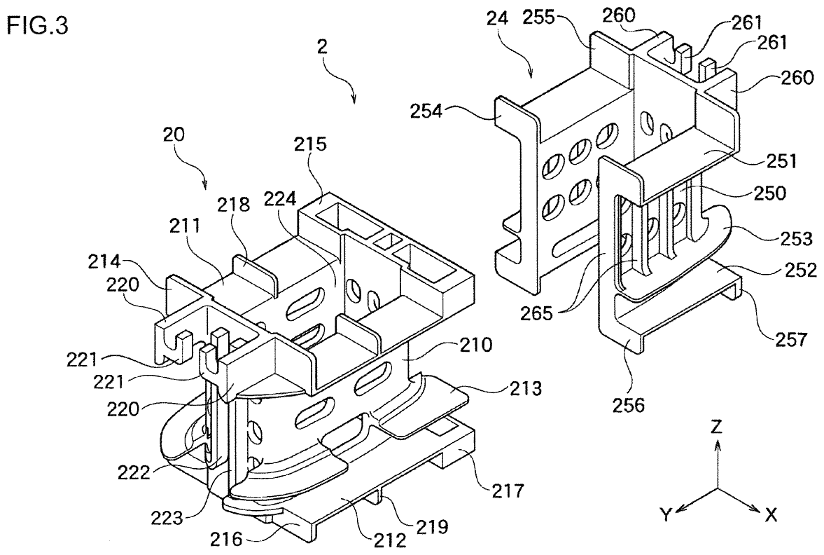

As shown in FIG. 3, the bobbin 2 includes a first bobbin 20 and a second bobbin 24. The bobbin 2 is configured of, for example, plastics such as PPS, PET, PBT, and LCP; or it may be configured of other insulation materials. The bobbin 2 is configured of two members which are the first bobbin 20 and the second bobbin 24; however, the bobbin 2 may be configured of one member. The first bobbin 20 includes a main body 210, flanges 211 and 212, a middle flange 213, wall parts 214 to 219, a projection 220, a hook 221, guides 222 and 223, and a through hole 224.

The main body 210 is a cylindrical body including the through hole 224. The through hole 224 extends along the axis direction of the main body 210. A flow passage hole which runs through the main body 210 from the outer circumference to the inner circumference of the main body 210. When the inside of the case 8 (FIG. 6) is filled with the resin 9, the resin 9 flows to the inside from the outside of the main body 210 via the flow passage hole. A plan view shape of the main body 210 is not particularly limited, and it may be elongated narrow shape in the Y-axis direction.

The flange 211 is formed on the upper end of the main body 210, and it projects from the outer circumference of the main body 210 along the radial direction of the main body 210. The flange 212 is formed at the lower end of the main body 210, and it projects from the outer circumference of the main body 210 along the radial direction of the main body 210. The intermediate flange 213 is positioned between the flange 211 and the flange 212, and it projects from the outer circumference of the main body 210 along the radial direction of the main body 210.

As shown in FIG. 4, the first wire 3 is wound around the outer circumference of the main body 210, and thereby the wound wire part 30 is formed. The overlapping part 32 is arranged between the flange 211 and the middle flange 213, and the non-overlapping part 33 is arranged between the middle flange 213 and the flange 212. That is, the middle flange 213 is positioned between the overlapping part 32 and the non-overlapping part 33, and the middle flange 213 separates the overlapping part 32 and the non-overlapping part 33. As shown in FIG. 5, in the present embodiment, the case 8 is filled with the resin 9 so that the surface (upper surface) of the resin 9 is positioned at the position of the middle flange 213. Note that, the position of the surface of the resin 9 may be lower than or higher than the position of the middle flange 213.

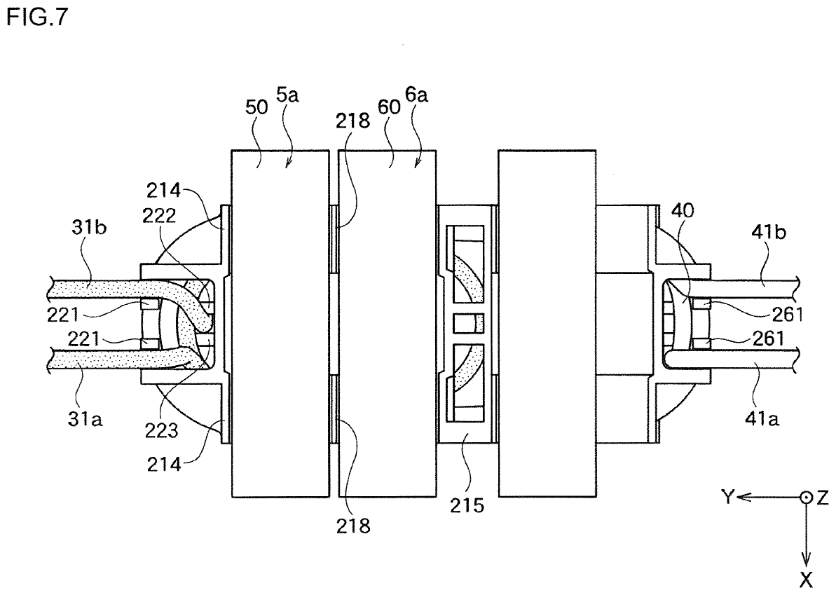

As shown in FIG. 3, the wall part 214 is positioned at one end part in the Y-axis direction of the flange 211, and the wall part 214 projects upward from the upper surface of the flange 211. The wall part 215 is positioned at the other end in the Y-axis direction of the flange 211, and the wall part 215 projects upwards from the upper surface of the flange 211. In the example shown in FIG. 3, a through hole (FIG. 7) is formed to the wall part 215.

The wall part 216 is positioned at one end in the Y-axis direction of the flange 212, and the wall part 216 projects downward from the lower surface of the flange 212. The wall part 217 is positioned at the other end in the Y-axis direction of the flange 212, and the wall part 217 projects downwards from the lower surface of the flange 212.

The wall part 218 is positioned between the wall part 214 and the wall part 215, and the wall part 218 projects upwards from the upper surface of the flange 211. The wall part 219 is positioned between the wall part 216 and the wall part 217, and the wall part 219 projects downward from the lower surface of the flange 212.

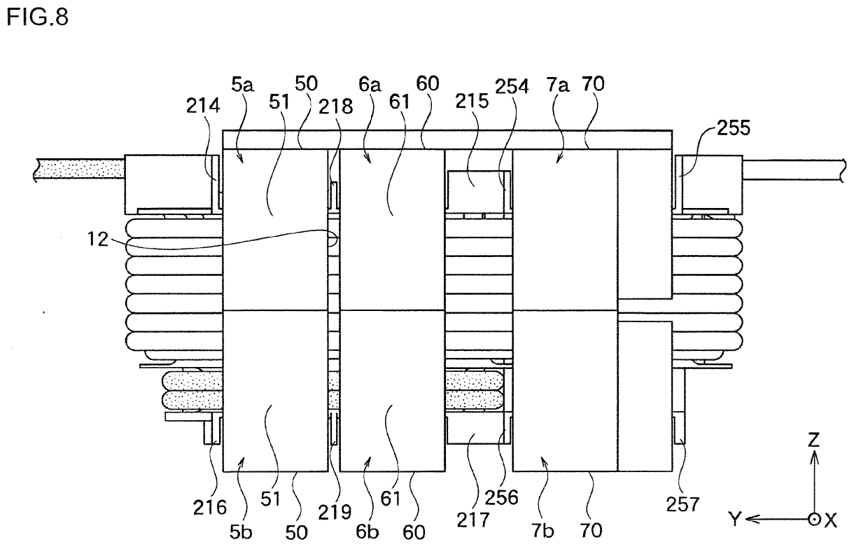

As shown in FIG. 7 and FIG. 8, the base part 50 of the first core 5a is arranged between the wall part 214 and the wall part 218. Also, the base part 60 of the second core 6a is arranged between the wall part 215 and the wall part 218. Also, the base part 50 of the first core 5b is arranged between the wall part 216 and the wall part 219. Also, the base part 60 of the second core 6b is arranged between the wall part 217 and the wall part 219.

As shown in FIG. 3, the pair of projections 220 projects from the wall part 214, and the projections 220 extend in a direction away from the second bobbin 24. The pair of hooks 221 projects from the pair of projections 220, and the hooks 221 project in the direction towards each other. The hooks 221 are bent in a L-like shape. The leadout part 31a (FIG. 7) engages with one of the hooks 221, and the leadout part 31b engages with the other one of the hooks 221.

The guides 222 and 223 are next to each other, and these are formed on the outer circumference of the main body 210. The guides 222 and 223 extend along the axis direction of the main body 210. As shown in FIG. 7, the leadout part 31b runs through the guides 222 and 223, and it is pulled out upwards from the wound wire part 30. Note that, as shown in FIG. 6, the leadout part 31b is pulled out upwards from the non-overlapping part 33. The leadout part 31a is pulled out upward from the upper end of the overlapping part 32.

As shown in FIG. 3, the second bobbin 24 includes the main body 250, flanges 251 and 252, a middle flange 253, wall parts 254 to 257, a projection 260, a hook 261, a raised part 265. In plan view, the main body 250 is curved in a C-like shape. The main body 250 has a flow passage hole penetrating the main body 250 from the outer circumference to the inner circumference of the main body 250. When filling the case 8 (FIG. 6) with the resin 9, the resin 9 flows to the inside from the outside of the main body 250 via the flow passage hole.

The flange 251 is formed on the upper end of the main body 250, and the flange 251 projects from the outer circumference of the main body 250 along the radial direction of the main body 250. The flange 252 is formed on the lower end of the main body 250, and the flange 252 projects from the outer circumference of the main body 250 along the radial direction of the main body 250. The middle flange 253 is positioned between the flange 251 and the flange 252, and the middle flange 253 projects from the outer circumference of the main body 250 along the radial direction of the main body 250. As shown in FIG. 4, the middle flange 253 is assembled to the middle flange 213. As shown in FIG. 6, the case 8 is filled with the resin 9 so that the surface (the upper surface) of the resin 9 is positioned at the position of the middle flange 253. Note that, the position of the surface of the resin 9 may be lower than or higher than the position of the middle flange 253.

As shown in FIG. 2 and FIG. 4, when the second bobbin 24 is assembled to the first bobbin 20, the second wire 4 can be wrapped around the outer circumference of the main body 250 and the outer circumference of the wound wire part 30. Thereby, the wound wire part 40 is formed around the outer circumference of the main body 250 and the outer circumference of the wound wire part 30. The wound wire part 40 is arranged between the flange 251 and the middle flange 253, and it is not arranged between the middle flange 253 and the flange 252.

As shown in FIG. 3, the wall part 254 is positioned at one end in the Y-axis direction of the flange 251, and the wall part 254 projects upwards from the upper surface of the flange 251. The wall part 255 is positioned at the other end in the Y-axis direction of the flange 251, and projects upwards from the upper surface of the flange 251.

The wall part 256 is positioned at the one end in the Y-axis direction of the flange 252, and the wall part 256 projects downward from the lower surface of the flange 252. The wall part 257 is positioned at the other end in the Y-axis direction of the flange 252, and the wall part 257 projects downwards from the lower surface of the flange 252. As shown in FIG. 4, the wall part 254 is assembled with the wall part 215, and the wall part 256 is assembled with the wall part 217.

As shown in FIG. 8, the base part 70 of the third core 7a is arranged between the wall part 254 and the wall part 255. Also, the base part 70 of the third core 7b is arranged between the wall part 256 and the wall part 257.

As shown in FIG. 3, the pair of projections 260 projects from the wall part 255, and the pair of projections 260 extends in the direction away from the first bobbin 20. The pair of hooks 261 projects from the pair of projections 260 so that each hook of the pair of hooks 261 extends toward each other. The hook 261 is bent in a L-like shape. The leadout part 41a (FIG. 7) engages with one of the pair of hooks 261, and the leadout part 41b engages with the other one of the pair of hooks 261. Note that, the lead out parts 41a and 41b are pulled upwards from the upper end of the wound wire part 40 in between the flange 251 and the middle flange 253.

The plurality of raised parts 265 is formed on the outer circumference of the main body 250, each of the plurality of raised parts 265 extends along the axis direction of the main body 250 between the flange 251 and the middle flange 253. The plurality of raised parts 265 projects from the outer circumference of the main body 250 along the radial direction of the main body 250. Since the plurality of raised parts 265 is formed on the outer circumference of the main body 250, the wound wire part 40 (FIG. 4) is arranged on the outer circumference of the main body 250 via the plurality of raised parts 265.

As shown in FIG. 2, the first heat dissipating member 10 is made of a plate-like member. The material configuring the first heat dissipating member 10 is not particularly limited, and examples include metals such as aluminum, copper, and silver. Ridges and grooves 100 are formed on the surface (upper surface) of the heat dissipating member 10. The ridges and grooves 100 are formed in a slit-like form. The ridges and grooves 100 include a plurality of ridges extending in the Y-axis direction, and a plurality of grooves extending in the Y-axis direction. The plurality of ridges and the plurality of grooves are aligned in the X-axis direction.

As shown in FIG. 1, the first heat dissipating member 10 is arranged on the base part 50 of the first core 5a, the base part 60 of the second core 6a, and the base part 70 of the third core 7a. The first heat dissipating member 10 may be directly arranged at least on the base part 50 and the base part 60, or the first heat dissipating member 10 may be indirectly arranged on the base part 50 and the base part 60. The first heat dissipating member 10 is for example provided on the base part 50, the base part 60, and the base part 70 using an adhesive.

As shown in FIG. 2, the second heat dissipating members 11a and 11b are each formed in a E-like shape. Materials configuring the second heat dissipating members 11a and 11b are not particularly limited, and examples include metals such as aluminum, copper, and silver. The second heat dissipating members 11a and 11b both have the same shapes; however, the shapes may be different. The second heat dissipating member 11a is assembled with the second heat dissipating member 11b. The second heat dissipating members 11a and 11b each respectively has a base part 110, a pair of outer leg parts 111, and a middle leg part 112.

The pair of outer leg parts 111 projects from the base part 110, and one outer leg part and the other outer leg part of the pair of the outer leg parts 111 are positioned opposite to each other in the X-axis direction. Each outer leg part of the pair of outer leg parts 111 is positioned at the end part of the base part 110 in the X-axis direction, and the pair of outer leg parts 111 extends in a direction perpendicular to the base part 110 (that is, extends in the Z-axis direction). The middle leg part 112 is positioned between the pair of outer leg parts 111, and projects from the base part 110.

Tips of the pair of outer leg parts 111 of the second heat dissipating member 11a may contact tips of the pair of outer leg parts 111 of the second heat dissipating member 11b, or gaps may be formed between these. A tip of the middle leg part 112 of the second heat dissipating member 11a may contact a tip of the middle leg part 112 of the second heat dissipating member 11b, or a gap may be formed between these.

On the end faces of the second heat dissipating members 11a and 11b in the Y-axis direction, ridges and grooves 113 may be formed. The ridges and grooves 113 are formed in a slit-like form. The ridges and grooves 113 are made of a plurality of ridges extending in the Z-axis direction, and a plurality of grooves extending in the Z-axis direction. The plurality of ridges and the plurality of grooves are aligned in the X-axis direction.

As shown in FIG. 9, the second heat dissipating member 11a is provided at the end face in the Y-axis direction of the third core 7a. The second heat dissipating member 11a is directly arranged on the end face in the Y-axis direction of the third core 7a; however, the second heat dissipating member 11a may be indirectly arranged on the end face in the Y-axis direction of the third core 7a. The second heat dissipating member 11b is provided at the end face in the Y-axis direction of the third core 7b. The second heat dissipating member 11b is directly arranged on the end face in the Y-axis direction of the third core 7b; however, the second heat dissipating member 11b may be indirectly arranged on the end face in the Y-axis direction of the third core 7b. For example, the second heat dissipating members 11a and 11b are installed to the third cores 7a and 7b using an adhesive.

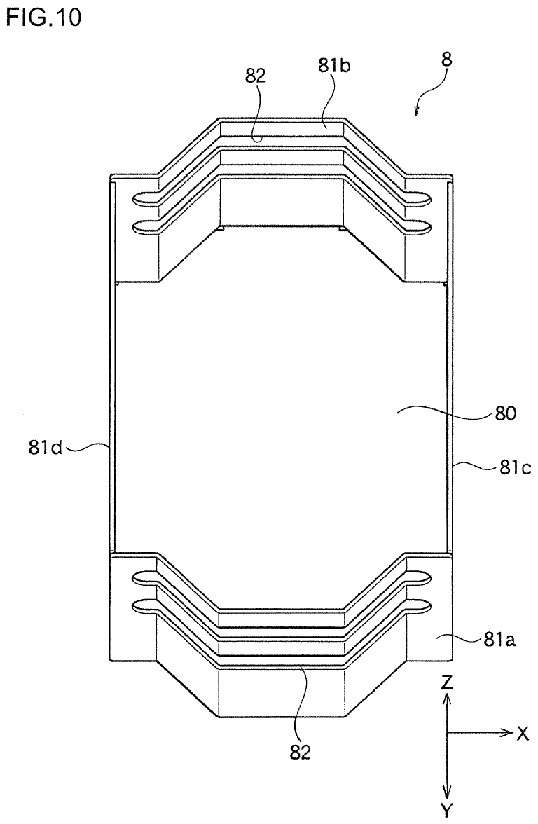

As shown in FIG. 10, the case 8 includes a base board 80, side boards 81a to 81d, and a communicating part 82. The case 8 is configured of metals such as aluminum having an excellent cooling property. The case 8 at least accommodates the bobbin 2.

The side boards 81a to 81d extend in a perpendicular direction with respect to the base board 80 (upper direction) from the circumference of the base board 80. The side boards 81a and 81b are positioned the opposite to each other in the Y-axis direction, and depending on the shape of the bobbin 2, it expands outwards from the case 8. The side board 81c and the side board 81d are positioned the opposite to each other in the X-axis direction.

The communicating part 82 is formed in a slit-like form, and when viewed from the Y-axis direction, the communicating part 82 is an elongated narrow shape extending in the X-axis direction. The communicating part 82 opened from the outer surface to the inner surface of the side boards 81a and 81b of the case 8 in the Y-axis direction from the outer surface to the inner surface of the side boards 81a and 81b. In the present embodiment, the communicating part 82 is a penetrating hole which penetrates the side boards 81a and 81b. Note that, the communicating part 82 is not limited to a penetrating hole, and it may be a notch which is made to the outer circumference of the side boards 81a and 81b. Alternatively, the communicating part 82 may be an indentation formed from the outer circumference of the side boards 81a and 81b.

In the example shown in FIG. 10, the side board 81a has two communicating parts 82 which are arranged one on top and the other on below. Similarly, the side board 81b has two communicating parts 82 which are arranged one on top and the other on below. The shape of the communicating part 82 when viewed from the vertical direction to the side boards 81a and 81b is substantially an oval shape or a rectangular shape; however, the shape may be a circular shape, a square shape, other polygonal shapes, and any other shape. Also, the number of the communicating parts 82 in the side boards 81a and 81b is not particularly limited to 2, and it may be 1, or 3 or more. For example, when viewed from the direction perpendicular to the side boards 81a and 81b, a plurality of circular shaped communicating parts 82 may be aligned in the X-axis direction.

As shown in FIG. 6, the communicating parts 82 are at the position spaced from the surface (upper surface) of the resin filling the case 8 and towards the direction (upper direction) of the opening of the case 8. The case 8 is filled with the resin 9 up to the same position where the communicating part 82 is formed; however, the resin 9 may be filled to the position lower than the position of the communicating part 82. Note that, the resin 9 is not particularly limited, and for example it may be configured of a silicone resin, a urethane resin, an epoxy resin, etc.

At least part of the outer circumference of the wound wire part 40 is facing outside of the case 8 through the communicating part 82. Also, the communicating part 82 is positioned at the position where the outer circumference of the wound wire part 40 can be seen from the outside of the case 8 through the communicating part 82. Thus, when cooling air is supplied to the coil device 1 in the Y-axis direction, at least part of the cooling air enters inside the case 8 through the communicating part 82. At least part of cooling air contacts the wound wire part 40, and thereby the wound wire part 40 can be cooled.

As shown in FIG. 8, in the present embodiment, the outer leg part 51 of the first core 5a and the outer leg part 61 of the second core 6a are apart from each other in the Y-axis direction. Also, the outer leg part 51 of the first core 5b and the outer leg part 61 of the second core 6b are apart from each other in the Y-axis direction. Therefore, a space 12 is formed between the outer leg part 51 and the outer leg part 61. A width of the space 12 in the Y-axis direction is about the same or greater than the width of the wall part 218 of the first bobbin 20 in the Y-axis direction. For example, the width of the space 12 in the Y-axis direction is ½ or greater than the diameter of the first wire 3 or the second wire 4. The space 12 is also formed between the base part 50 and the base part 60 in addition to between the outer leg part 51 and the outer leg part 61.

As mentioned in above, at least part of the cooling air flows inside the case 8 through the communicating part 82. At least part of the cooling air flows out of the cores 5a and 5b through the space 12 which is positioned between the outer leg part 51 and the outer leg part 61. As such, in the present embodiment, the communicating part 82 functions as the entrance for the cooling air to enter inside the case 8, and also the space 12 functions as the exit for the cooling air to exert from the cores 5a and 5b. Therefore, from the communicating part 82 to the space 12, a flow passage of the cooling air is formed so that the cooling air flows around the outer circumference of the wound wire part 40.

Note that, in the present embodiment, the outer leg parts 61 of the second cores 6a and 6b and the outer leg parts 71 of the third cores 7a and 7b are spaced apart along the Y-axis direction. Therefore, a space which functions as an air flow passage is also formed between the outer leg part 61 and the outer leg part 71.

Next, a method for producing the coil device 1 is described in below. First, the first wire 3 (FIG. 4) is wound around the outer circumference of the main body 210 of the first bobbin 20 shown in FIG. 3 to form the first wound wire part 30. Then, the first wire 3 is pulled out from the wound wire part 30 (FIG. 4) and passes through the hooks 221; thereby, the leadout parts 31a and 31b are formed. Next, as shown in FIG. 4, the second bobbin 24 is assembled to the first bobbin 20 to which the first wire 3 is wound. Next, the second wire 4 is wound around the outer circumference of the wound wire part 30 and the outer circumference of the main body 250 of the second bobbin 24 to form the wound wire part 40 shown in FIG. 2. Then, the second wire 4 is pulled out from the wound wire part 40 and passes through the hooks 261; thereby, the leadout parts 41a and 41b are formed.

Next, as shown in FIG. 9, the first cores 5a and 5b, the second cores 6a and 6b, and the third cores 7a and 7b are assembled to the bobbin 2 (the assembled body of the first bobbin 20 and the second bobbin 24). Then, the first heat dissipating member 10 is installed to the base part 50, the base part 60, and the base part 70. Also, the second heat dissipating members 11a and 11b are installed to the second cores 7a and 7b. Then, as shown in FIG. 1, the bobbin 2 and so on are accommodated in the case 8, and the resin 9 is placed in the case 8 as shown in FIG. 5. As discussed hereinabove, the coil device 1 can be produced.

As shown in FIG. 1, in the coil device 1 of the present embodiment, in the Y-axis direction which is perpendicular to the axis direction of the bobbin 2 (the Z-axis direction) and in the direction that the outer leg parts 51 are opposed to each other (the X-axis direction), the outer leg part 51 is spaced from the outer leg part 61 so that the space 12 is formed between the outer leg part 51 and the outer leg part 61. Therefore, at least part of the cooling air supplied to the wound wire part 40 flows along the outer circumference of the wound wire part 40 and flows to the outside from the inside of the first core 5a and the second core 6a through the space 12 formed between the outer leg part 51 and the outer leg part 61. Thereby, the wound wire part 40 is cooled, and improves the heat dissipating property of the coil device 1. Also, there is no need to process the first core 5a and the second core 6a in order to secure the flow passage of the cooling air; thus, it is possible to enhance the heat dissipating property of the coil device 1 while having a simple structure.

Also, as shown in FIG. 5, the wound wire part 30 includes the overlapping part 32 where the wound wire part 30 and the wound wire part 40 are overlapped along the radial direction of the wound wire part 30, and the non-overlapping part 33 where the wound wire part 30 and the wound wire part 40 are not overlapping along the radial direction of the wound wire part 30. Further, the non-overlapping part 33 is arranged inside the resin 9. Therefore, heat of the wound wire part 30 is transferred to the resin 9 through the non-overlapping part 33; hence, the wound wire part 30 can be cooled effectively. Also, the overlapping part 32 is exposed from the resin 9. Thus, the cooling air supplied to the wound wire part 40 easily reaches the overlapping part 32; hence, the wound wire part 30 can be cooled effectively.

Also, as shown in FIG. 1, the case 8 includes the communicating part 82 penetrating the case 8 in the Y-axis direction from the outer surface to the inner surface of the case 8. Thus, when the cooling air is supplied in the Y-axis direction, the cooling air enters inside the case 8 through the communicating part 82. Thereby, the cooling air easily reaches the wound wire part 40, and the wound wire part 40 can be cooled effectively.

Also, as shown in FIG. 6, the communicating part 82 is positioned at the position spaced from the surface of the resin 9 and towards the opening of the case 8. Therefore, the cooling air which flew into the case 8 through the communicating part 82 easily reaches the wound wire part 40, and the wound wire part 40 can be cooled effectively.

Also, as shown in FIG. 1, the coil device 1 includes the first heat dissipating member 10 which is formed with the ridges and grooves 100. Further, the first heat dissipating member 10 is directly or indirectly arranged on the base part 50 and the base part 60. Thus, the first core 5a and the second core 6a can dissipate heat through the first heat dissipating member 10.

Also, as shown in FIG. 6, at least one of the wound wire part 30 and the wound wire part 40 includes a transformer part 13 functioning as a transformer and an inductor part 14 functioning an inductor. Hence, the coil device 1 includes both of the functions as a transformer and an inductor. Thus, it is possible to downsize the electronic device compared to the case of mounting the transformer and the inductor separately to the electronic device.

Also, as shown in FIG. 9, the coil device 1 includes the third core 7a which is next to the first core 5a or the second core 6a (in the present embodiment, it is next to the second core 6a) along the Y-axis direction, and also includes the second heat dissipating member 11a formed with the ridges and grooves 113. The third core 7a is arranged to the inductor part 14, and the second heat dissipating member 11a is directly or indirectly arranged on the end surface in the Y-axis direction of the third core 7a. Thus, the third core 7a can dissipate heat through the second heat dissipating member 11a even though the cooling air can not easily reach the third core 7a compared to the first core 5a and the second core 6a.

### Second Embodiment

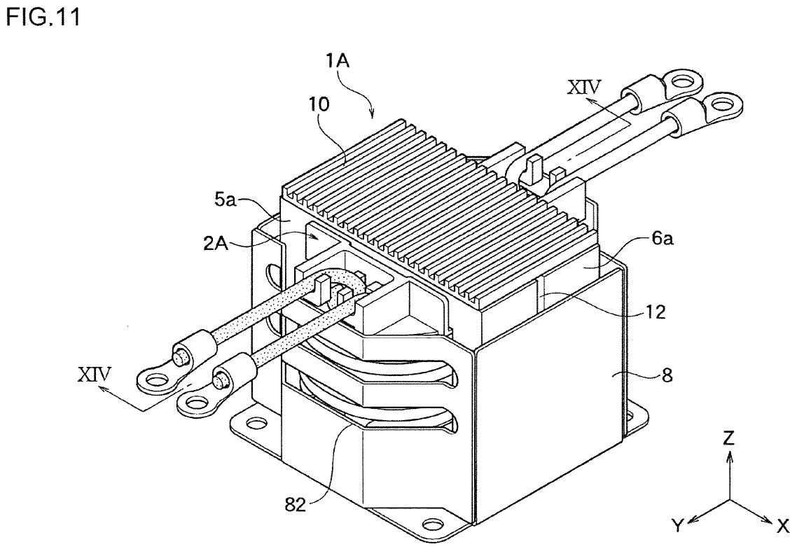

A coil device 1A of the second embodiment shown in FIG. 11 basically has the same configuration as the first embodiment except for the points described in below. For the parts which are the same as the coil device 1 of the first embodiment are given with the same numerical references, and the detailed explanations will be omitted.

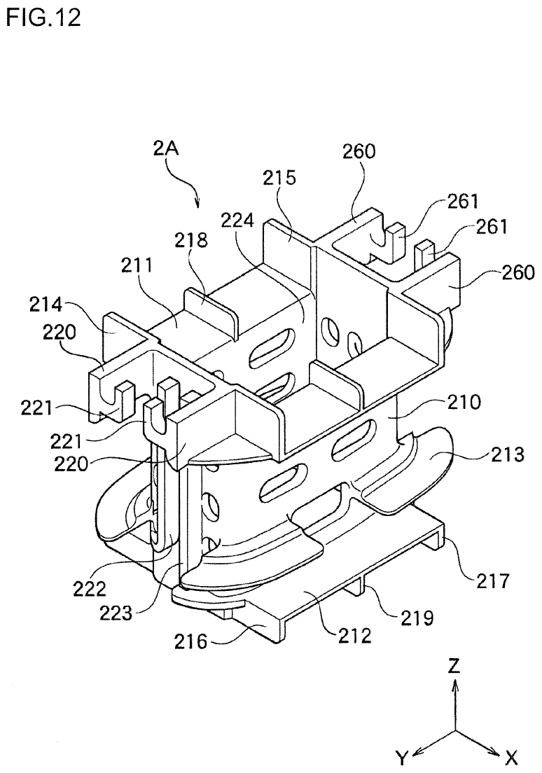

As shown in FIG. 12, the coil device 1A has a bobbin 2A. The bobbin 2A is made of a single bobbin. The bobbin 2A has a structure similar to the first bobbin 20 of the first embodiment but added with the projections 260 and the hooks 261 of the second bobbin 24. The pair of projections 260 projects from the wall part 215, and extends in a direction away from the center of the bobbin 2A. The pair of hooks 261 projects from the pair of projections 260 and extends in a direction approaching closer to each other.

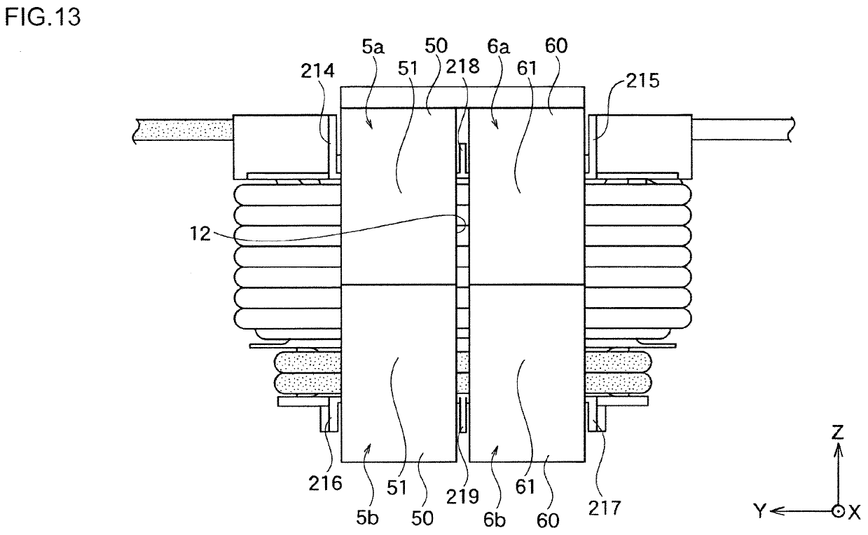

As shown in FIG. 13, the coil device 1A includes the first cores 5a and 5b, the second cores 6a and 6b; however, unlike the first embodiment, the coil device 1A does not include the third cores 7a and 7b. In the coil device 1A of the present embodiment, the function of the inductor part 14 (FIG. 6) is omitted from the coil device 1 of the first embodiment; thus, the coil device 1A substantially functions as a transformer.

As shown in FIG. 13, in the present embodiment, the outer leg part 51 and the outer leg part 61 are spaced apart along the Y-axis direction so as to form the gap 12 between the outer leg part 51 and the outer leg part 61. Thus, similar effect can be obtained.

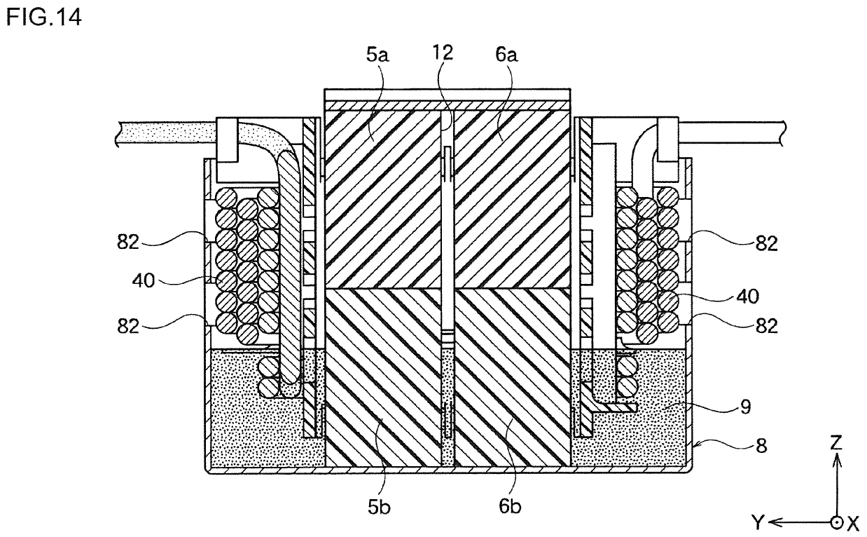

Also, as shown in FIG. 14, the case 8 includes the communicating part 82 penetrating the case 8 in the Y-axis direction from the outer surface to the inner surface of the case 8. Hence, when the cooling air is supplied in the Y-axis direction, the cooling air flows into the case 8 through the communicating part 82. Thereby, the cooling air can easily reach the wound wire part 40 and it is possible to effectively cool the wound wire part 40.

Note that, the present disclosure is not limited to the above-mentioned embodiments, and various modifications are possible within the scope of the present disclosure.

As shown in FIG. 5, in the above-mentioned embodiments, the wound wire part 40 is layered over the wound wire part 30 along the radial direction of the wound wire part 30; however, the wound wire part 40 and the wound wire part 30 may be arranged vertically one on top and the other on below along the winding axis direction of the wound wire part 30.

Also, part of the wound wire part 40 (for example, the lower end) may be arranged inside the resin 9.

### REFERENCE SIGNS LISTS

1, 1A . . . Coil device
2, 2A . . . Bobbin
   20 . . . First bobbin
   210 . . . Main body
   211, 212 . . . Flange
   213 . . . Middle flange
   214 to 219 . . . Wall part
   220 . . . Projection
   221 . . . Hook
   222, 223 . . . Guide
   224 . . . Through hole
   24 . . . Second bobbin
   250 . . . Main body
   251, 252 . . . Flange
   253 . . . Middle flange
   254 to 257 . . . Wall part
   260 . . . Projection
   261 . . . Hook
   265 . . . Raised part
3 . . . First wire
   30 . . . Wound wire part
   31a, 31b . . . Leadout part
   32 . . . Overlapping part
   33 . . . Non-overlapping part
4 . . . Second wire
   40 . . . Wound wire part
   41a, 41b . . . Leadout part
5a, 5b . . . First core
   50 . . . Base part
   51 . . . Outer leg part
   52 . . . Middle leg part
6a, 6b . . . Second core
   60 . . . Base part
   61 . . . Outer leg part
   62 . . . Middle leg part
7a, 7b . . . Third core
   70 . . . Base part
   71 . . . Outer leg part
   72 . . . Middle leg part
8 . . . Case
   80 . . . Base board
   81a to 81d . . . Side board
   82 . . . Communicating part
9 . . . Resin
10 . . . First heat dissipating member
   100 . . . Ridges and grooves
11a, 11b . . . Second heat dissipating member
   110 . . . Base part
   111 . . . Outer leg part
   112 . . . Middle leg part
   113 . . . Ridges and grooves
12 . . . Space
13 . . . Transformer part
14 . . . Inductor part

What is claimed is:

1. A coil device comprising:
a bobbin;
a first wound wire part arranged around an outer circumference of the bobbin;
a second wound wire part arranged directly or indirectly around an outer circumference of the first wound wire part;
a first core and a second core installed to the bobbin;
a case at least accommodating the bobbin; and
a resin provided in the case;
wherein the first core comprises a first base part and a pair of first outer leg parts projecting from the first base part, and one outer leg part and an other outer leg part of the pair of first outer leg parts are positioned opposite to each other in a first direction perpendicular to an axis direction of the bobbin,
the second core comprises a second base part and a pair of second outer leg parts projecting from the second base part, and one outer leg part and an other leg part of the pair of second outer leg parts are positioned opposite to each other in the first direction, and
the pair of first outer leg parts and the pair of second outer leg parts are spaced apart so as to form a space between the pair of first outer leg parts and the pair of second outer leg parts along a second direction perpendicular to the axis direction and the first direction.

2. The coil device according to claim 1, wherein the first wound wire part comprises an overlapping part where the second wound wire part and the first wound wire part overlap along a radial direction of the first wound wire part, and a non-overlapping part where the second wound wire part and the first wound wire part are not overlapping along the radial direction of the first wound wire part; and
the non-overlapping part is arranged inside of the resin.

3. The coil device according to claim 2, wherein the overlapping part is exposed from the resin.

4. The coil device according to claim 1, wherein the case comprises a communicating part opened from an outer surface to an inner surface of the case in the second direction.

5. The coil device according to claim 4, wherein the communicating part is positioned at a position which is away from the surface of the resin in a direction toward an opening of the case.

6. The coil device according to claim 1 further comprising a first heat dissipating member having ridges and grooves, wherein the first heat dissipating member is arranged directly or indirectly on the first base part and the second base part.

7. The coil device according to claim 1, wherein at least one of the first wound wire part and the second wound wire part comprises a transformer part functioning as a transformer, and an inductor part functioning as an inductor.

8. The coil device according to claim 7 further comprising a third core adjacent to the first core or the second core along the second direction, and a second heat dissipating member having ridges and grooves,
wherein the third core is arranged to the inductor part, and
the second heat dissipating member is directly or indirectly arranged on an end surface in the second direction of the third core.
